(19) United States
(12) Patent Application Publication
(10) Pub. No.: US 2008/0030336 A1
(43) Pub. Date: Feb. 7, 2008

(54) SEMICONDUCTOR INTEGRATED CIRCUIT DEVICE AND RECEIVING DEVICE

(76) Inventors: Takefumi ENDO, Tokyo (JP); Hiroto Utsunomiya, Tokyo (JP); Akihiro Takano, Kodaira (JP); Seiichi Iwata, Yokohama (JP); Kazuyoshi Watanabe, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/831,084

(22) Filed: Jul. 31, 2007

(30) Foreign Application Priority Data
Aug. 1, 2006 (JP) JP 2006-210353
Aug. 1, 2006 (JP) JP 2006-210360
Mar. 29, 2007 (JP) JP 2006-089313

(51) Int. Cl. H04L 27/00

(52) U.S. Cl. 340/572.1; 375/216

(57) ABSTRACT

A technique that can reduce a size of a circuit in a radio receiver device such as a reader-writer device of RFID is provided. In a semiconductor integrated circuit device (IC) used for a transceiver such as a reader-writer in a UHF band electronic tag system, an operating unit including a multiplier, an adder, and a register is disposed between a baseband signal generating unit and a DAC unit. By this structure, an ASK modulation depth and a DC bias of an ASK modulation signal can be adjusted with a simple configuration.

### CROSS-REFERENCE TO RELATED APPLICATION

The present application claims priority from Japanese Patent Applications No. JP 2007-089313 filed on Mar. 29, 2007, No. JP 2006-210353 filed on Aug. 1, 2006, and No. JP 2006-210360 filed on Aug. 1, 2006 the contents of which are hereby incorporated by reference into this application.

### TECHNICAL FIELD OF THE INVENTION

The present invention relates to a radio communication technique, in particular, to a semiconductor integrated circuit device for a radio transmitter that achieves an adjustment of transmission spectrum, and a technique that is effective in application to a configuration of a high frequency front-end unit used for a reader-writer device of radio frequency identification (RFID).

### BACKGROUND OF THE INVENTION

Among techniques studied by the present inventors, for a wireless transceiver, for example, following techniques can be considered.

For example, Japanese Patent Application Laid-Open Publication No.2000-182003 (Patent Document 1) discloses a technique about transceiver device connected to a higher-level device to perform radio communication with an information storage medium. In order to perform radio communication confirming to a plurality of specification by facilitating setup, change, adjustment of variation, the transceiver device comprises a digital unit including a control circuit having a CPU and a memory, an analogue unit, a capacitor and a coil. The digital unit includes a modulation circuit. The modulation circuit includes a shift register converting a parallel data, which is transmission data of 8-bit transmitted from the CPU, into a serial data and encodes the serial data from the shift register. The modulation circuit further includes two registers latching parallel data for setting modulation depth and weighting of an output level. One of outputs of the two registers is selected by a select circuit according to a result of encoding by a code generator. An output from the select circuit is outputted to an analogue unit.

Further, Japanese Patent Application Laid-Open Publication No. 9-8675 (Patent Document 2) relates to a radio communication device performing burst transmission. In order to provide a transmitter that suppresses spectrum spread at burst transmission by smoothening rising and falling of the burst signal, the power terminal of an amplifier that receives a high-frequency input signal is provided with a power supply voltage via a circuit having a time constant, and turning on/off of the power supply voltage is performed via a switch operating according to a control signal. As a result, a burst-like high frequency output signal that rises and falls smoothly in accordance with the control signal is obtained.

“A method of characteristic test of a radio communication equipment using radio wave of frequency higher than 952 MHz and equal to or lower than 954 MHz used for a premises radio station” Rev. 4.0, pp. 23, 24, 27 to 30, 34 and 35, Telecom Engineering Center, Jan. 31, 2006 (Non-Patent Document 1) relates to a transmission-time limiting device and a technical standard in a method of characteristic test of a premises radio station (identification of a mobile object of 950 MHz band).

“A method of characteristic test of a radio communication equipment used for a specified low power radio station for identification of a mobile object using radio wave of frequency higher than 952 MHz and equal to or lower than 954 MHz” Rev. 1.0, pp. 18, 19, 22 to 24 and 25, Telecom Engineering Center, Jan. 31, 2006 (Non-Patent Document 2) relates to a transmission-time limiting device and a technical standard in a method of characteristic test of a specified low power radio station for identification of a mobile object of 950 MHz band.

Further, the following techniques can be considered in a reader-writer device of RFID.

A modulation method of a signal sent from an RFID tag to the reader-writer device is an amplitude shift keying (ASK) modulation, and the modulation method is generally a lord modulation (a modulation method performed by changing an amount of reflected wave from the RFID tag by changing antenna impedance according to transmission data using turning on and off of a switch disposed between antenna terminals and the like).

The reader-writer device detects and amplifies an ASK-modulated wave, binarizes the wave to a digital value, and decodes the digital value to obtain an accurate response signal from the RFID. Here, a direction in which a signal in the reflected wave changes varies according to impedance matching condition between antennas of the RFID tag with the switch disposed between the antenna terminals in off-state an IC chip.

For example, in the case where the condition is substantial perfect-matching, the impedance matching condition deteriorates by turning on the switch disposed between the antennas of the RFID tag. Since the reflected wave is weak under the impedance matching condition, a level of the reflected wave increases when the switch disposed between the antennas of the RFID tag is turned on from off.

On the contrary, in the case where the condition is not matched, the impedance matching condition may be improved by turning on the switch disposed between the antennas of the RFID tag. In such a case, the level of the reflected wave decreases.

RFID tags are attached on various objects to be used. However, since the dielectric constants are not constant in these objects, the impedance matching condition between the antenna and the IC chip changes. As a result, variation of the direction in which the signal of the reflected wave changes described above occurs.

The reader-writer device is required to receive the signal in both cases where the reflected signal changes in a positive direction (a reflected wave increases) and where the reflected signal changes in a negative direction (a reflected wave decreases), and therefore demodulator circuits dedicated for respective signals are provided.

Further, before the reader-writer device emits a radio wave, it is required to confirm that a frequency channel intended for use is not used, that is carrier sense, in order to carry out communication without interfering with other reader-writer systems. (Note that this applies in Japanese Radio Law, and is not necessary in the U.S.A due to sharing by frequency hopping.)

For realization of the function, some methods are possible in accordance with a receiving method of a desired wave. For example, there are a method in which a carrier frequency is transformed into a DC value directly and a method in which after a transformation into an intermediate frequency (IF) is performed, demodulation is executed in an ASK demodulating circuit, such as a heterodyne method, and a Low-IF method.

Note that, as techniques regarding to such an RFID reader-writer device, for example, techniques described in Japanese Patent Application Laid-Open Publication No. 2004-535700 (Patent Document 3), Non-Patent Document 1, and Non-patent document 3 can be cited.

Patent Document 3 relates to a radio frequency identification (RFID) interrogator that generates a radio frequency interrogation signal selected in a pseudorandom manner for a transmission to the first antenna and receives a modulated radio frequency signal that has been reflected by the RFID tag device via continuous back scatter through the second antenna connected to a heterodyne receiver from which the data is extracted.

Non-patent Document 1 relates to a carrier sense function in the method of characteristic test of a premises radio station (identification of a mobile object of 950 MHz band).

Non-patent Document 2 relates to a carrier sense function in the method of characteristic test of a specified low power radio station for identification of a mobile object of 950 MHz band.

### SUMMARY OF THE INVENTION

Here, as results of studies about techniques of the radio transmitter described above by the inventors, followings are found out.

For example, since the technique described in patent document 1 uses software control, a high-performance and large scale operating circuit (a CPU and an information storage medium) is required, as a result, a size of the circuit increases. Therefore, it is not suitable for a radio transmitter that does not require complex adjustments or a device desired to be small.

Moreover, the operations are performed by software, it takes time to response, and the processing takes a long time.

Further, since no care is prepared to suppress spectrum spread at burst communication, external operations as described in Patent Document 2 are required. And, start-up time is required, and therefore this technique is not suitable for a radio transmitter that requires burst transmission and spectrum control.

And, as results of studies about techniques of the reader-writer device of RFID described above, following two problems are found out.

Firstly, for example, as described above, the reader-writer device that receives a response from the RFID is required to modulate both the reflected signal with change in the positive direction and the reflected signal with change in the negative direction correctly. Therefore, demodulating circuits dedicated for processing respective signals are required. As a result, the demodulating circuits dedicated for respective signals are provided, and a size of the circuit increases. In the case of realizing in IC chip, there is a disadvantage that the chip size becomes large.

Secondly, in order to realize the carrier sense described above, in the method in which after transforming into the IF frequency, the demodulation is performed in the ASK modulation circuit, such as the heterodyne method and the Low-IF method, a mechanism that suppresses an image frequency is required, and therefore there is a disadvantage in terms of a circuit size.

And, in the case of the direct conversion method, in which the baseband signal is obtained directly, since a carrier frequency component is converted into the DC form, if an input signal is a non-modulated wave, the signal becomes a DC component only. If the input signal is small, it is difficult to separate the input signal from a DC offset voltage generated in the circuit.

FIG. 12 is an explanation diagram showing a process of the frequency transform at performing carrier sense in the direct conversion method.

Note that, in a following explanation, “usual signal processing” does not mean carrier sense but a signal processing system from the direct conversion to a binarization in the case of reception of a response signal from the RFID.

As shown in FIG. 12, in the direct conversion method, in the case where a frequency channel which is subject to carrier sense includes a modulated wave, signal processing using the usual signal processing is possible because the modulated signal is frequency-transformed into the same band as that used on reception of a response from the RFID after the direct conversion. However, in the case where the frequency channel which is subject to carrier sense includes a non-modulated wave, the frequency of the modulated wave after the frequency transform is in the DC form. If the input signal is small, a problem that it is difficult to separate the input signal from a DC offset voltage generated in the circuit occurs.

FIG. 13 is an explanation diagram showing a process of the frequency transform at performing carrier sense in the heterodyne method.

As shown in FIG. 13, in the heterodyne method, since both a modulated wave and a non-modulated wave are transformed into an IF frequency, the problem found in the direct conversion system does not occur. However, since the IF frequency after the frequency transform is high, a filter in the usual signal processing system for suppression of unnecessary signals cannot be used, and a problem that another filter is required occurs. Further, since the filter requires strict specification on bandwidth with respect to a center frequency compared to that for the usual signal processing system, usually, it is difficult to design the filter.

FIG. 14 is an explanation diagram showing a process of a frequency transformation at performing carrier sense in the Low-IF method.

As shown in FIG. 14, in the Low-IF method also, since both a modulated wave and a non-modulated wave are transformed into an IF frequency, the problem found in the direct conversion method does not occur. Although the problems that the filter in the usual signal processing system for suppression of unnecessary signals cannot be used for the IF frequency, and that another filter is required occur, since the IF frequency after the frequency transform is relatively low, a specification required by the filter for the IF frequency on the bandwidth with respect to the center frequency is loose in comparison with that for the heterodyne method, and therefore it is relatively easy to design the filter.

However, in the Low-IF method, since the image frequency is in-band, the image frequency cannot be suppressed by an antenna filter. And therefore, it is required to suppress the image frequency by a circuit using an image rejection mixer technique or the like. There is a problem that the circuit for the suppression is required newly.

Thus, one object of the present invention is to provide a technique that can reduce a size of a circuit in the radio transceiver device.

The above and other objects and novel features of the present invention will be apparent from a description of the present specification and accompanying drawings.

An outline of typical elements of the invention disclosed in this application is described briefly as follows.

That is, in a semiconductor integrated circuit device according to the present invention, by providing a multiplier and an adder between a baseband signal generating unit and a DAC unit, adjustments of an ASK modulation depth and a DC bias of an ASK modulated signal can be performed easily.

A receiver device according to the present invention is a receiver device of a direct conversion method comprising a first amplifier unit to which a high frequency reception signal is inputted, a demodulator unit to which an output of the first amplifier unit is inputted, a filter to which an output of the demodulator unit is inputted, a second amplifier unit to which an output of the filter is inputted, and a binarizing circuit to which an output of the second amplifier unit is inputted. The receiver device is characterized by that the binarizing circuit includes an offset-plus adding system circuit and an offset-minus adding system circuit; the receiver device includes a wave detecting circuit to which an output of the second amplifier unit is inputted and a comparator circuit to which an output of the wave detecting circuit is inputted; or the binarizing circuit includes an offset-plus adding system circuit and an offset-minus adding system circuit and the receiver device includes a wave detecting circuit to which an output of the second amplifier is inputted and a comparator circuit to which an output of the wave detecting circuit is inputted.

Effects obtained by typical elements of the invention disclosed in this application are described briefly as follows.
(1) An information storage medium and a high performance operating circuit are unnecessary, and high integration and miniaturization can be achieved easily.
(2) By adjusting the modulation depth and the DC bias according to a communication establishment condition, a communication success rate can be increased and a performance as a system can be improved in the case of communication where relatively long communication time is not required.
(3) Because of an adjustment by an operating unit in former stage of the DAC unit, a fine adjustment can be performed.
(4) By interlocking the baseband signal generating unit and the operating unit, spectrum spread which occurs at risings and failings can be suppressed, and a time constant circuit realized at the outside is unnecessary.
(5) In a receiver device such as an RFID reader-writer device, the number of components can be decreased and a size of the circuit can be reduced. And therefore, a manufacturing cost and packaging area thereof can be reduced.

### BRIEF DESCRIPTIONS OF THE DRAWINGS

FIG. 1A is a diagram showing an envelope specification of the ISO/IEC, 18000-6, type C;

FIG. 1B is a diagram showing the envelope specification of the ISO/IEC, 18000-6, type C;

FIG. 1C is a diagram showing the envelope specification of the ISO/IEC, 18000-6, type C;

FIG. 2A is a block diagram showing a configuration of a semiconductor integrated circuit device according to an embodiment 1 of the present invention;

FIG. 2B is a block diagram showing the configuration of the semiconductor integrated circuit device according to the embodiment 1 of the present invention;

FIG. 3 is a diagram showing examples of wave processing in an operating unit in the semiconductor integrated circuit device according to the embodiment 1 of the present invention;

FIG. 4A is a block diagram showing a configuration of a semiconductor integrated circuit device according to an embodiment 2 of the present invention;

FIG. 4B is a block diagram showing the configuration of the semiconductor integrated circuit device according to the embodiment 2 of the present invention;

FIG. 5 is a block diagram showing a configuration of a semiconductor integrated circuit device according to an embodiment 3 of the present invention;

FIG. 6 is a block diagram showing a basic configuration of a receiver device according to an embodiment 4 of the present invention;

FIG. 7 is a block diagram showing a specific configuration of the receiver device according to the embodiment 4 of the present invention;

FIG. 8A is a diagram showing a configuration of a binarizing circuit of FIG. 7 in detail;

FIG. 8B is a diagram showing the configuration of the binarizing circuit of FIG. 7 in detail;

FIG. 9A is a diagram showing waveforms of each signal in the case where each input of an offset-plus adder and an offset-minus adder is a positive signal;

FIG. 9B is a diagram showing waveforms of each signal in the case where each input of the offset-plus adder and the offset-minus adder is a positive signal;

FIG. 9C is a diagram showing waveforms of each signal in the case where each input of the offset-plus adder and the offset-minus adder is a positive signal;

FIG. 10A is a diagram showing waveforms of each signal in the case where each input of the offset-plus adder and the offset-minus adder is a negative signal;

FIG. 10B is a diagram showing waveforms of each signal in the case where each input of the offset-plus adder and the offset-minus adder is a negative signal;

FIG. 10C is a diagram showing waveforms of each signal in the case where each input of the offset-plus adder and the offset-minus adder is a negative signal;

FIG. 11 is an explanation diagram showing a process of a frequency transform at performing carrier sense in the receiver device according to the embodiment 4 of the present invention;

FIG. 12 is an explanation diagram showing a process of a frequency transform at performing carrier sense in a direct conversion method;

FIG. 13 is an explanation diagram showing a process of a frequency transform at performing carrier sense in a heterodyne method;

FIG. 14 is an explanation diagram showing a process of a frequency transform at performing carrier sense in a Low-IF method;

FIG. 15 is a block diagram showing a basic configuration necessary for carrier sense in the present invention; and

FIG. 16 is a block diagram showing an example of a carrier sense circuit in the present invention.

### DESCRIPTIONS OF THE PREFERRED EMBODIMENTS

Hereinafter, embodiments of the present invention will be described in detail with reference to drawings. Note that, in all drawings for describing the embodiments, the same members are assigned with the same symbols in principal and duplicate descriptions will be omitted.

The present invention relates to, for example, a radio transmitter in an electronic tag system. The electronic tag system is under a process for an international standardization by ISO/IEC, JTC1, and the UHF band electronic tag system is supposed to use 860 to 960 MHz band. And, the standardization at ISO/IEC, JTC1 defines a communication protocol which is connection procedures between a reader-writer and the electronic tag in addition to requirements in terms of radio techniques (a modulating method, a coding method, a communication speed or the like), and two types of specifications, that is, ISO/IEC, 18000-6, type A, and type B are established.

Further, the standardization of the electronic tag system is also under process in EPCglobal, and Class 1 Generation 2 specification is established as the UHF band. The EPCglobal proposed the Class 1 Generation 2 specification to ISO/IEC, JTC1, and they are standardized as ISO/IEC, 18000-6, type C.

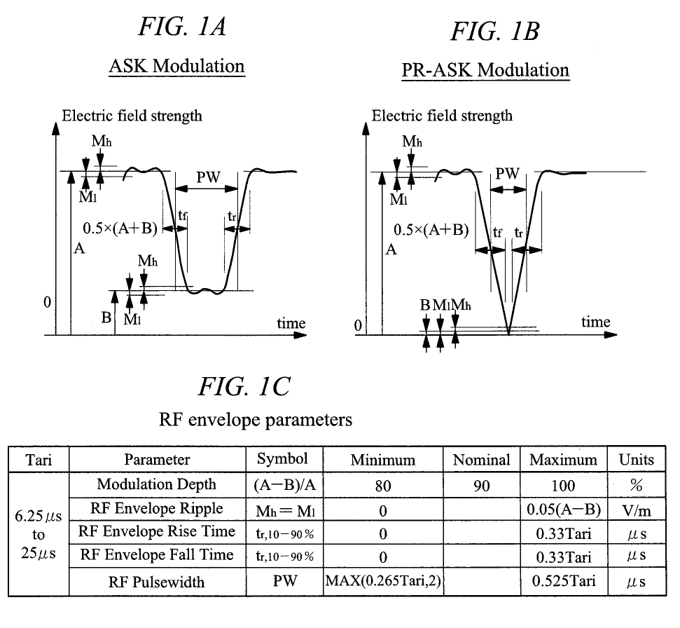

FIGS. 1A, 1B, and 1C are diagrams showing envelope specifications in ISO/IEC, 18000-6 type C. FIG. 1A shows a waveform of an ASK modulation, FIG. 1B shows a waveform of a PR-ASK modulation, and FIG. 1C shows RF envelop parameters.

The present invention has been invented during a review of a semiconductor integrated circuit device for a reader-writer as a radio transmitter that conforms to ISO/IEC, 18000-6, type C in order to satisfy the specification shown in FIGS. 1A to 1C. The present invention relates to, in the specification, control of a modulation depth ((A-B)/A), which has influence on success of communication, and an RF envelope rise time (tr), an RF envelope fall time (tf), and an RF pulsewidth (PW), which have influence on a spectrum mask (a transmit mask), by a digital circuit.

And, the present invention takes account of the spectrum mask of the rising and the falling at burst communication (TELEC-T240, T242, transmission time control device specification), as described in Non-patent Document 1 and Non-patent Document 2.

### Embodiment 1

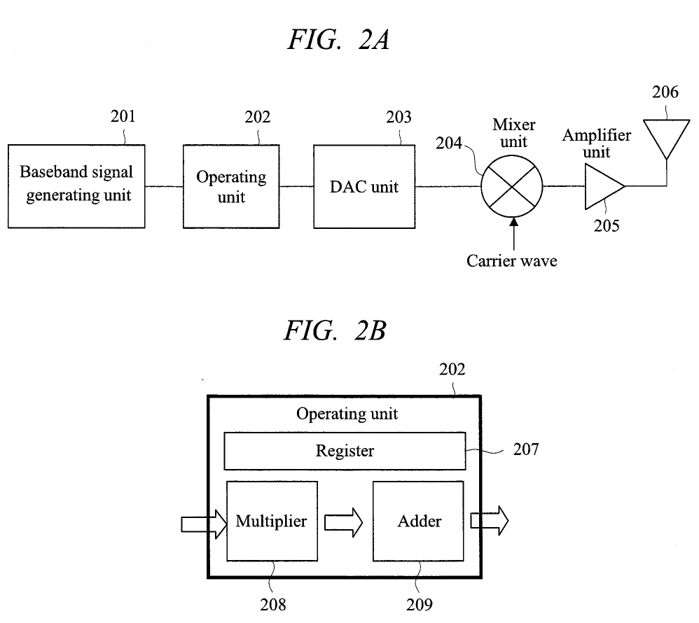

FIG. 2A is a block diagram showing a configuration of a semiconductor integrated circuit device according to an embodiment 1 of the present invention, and FIG. 2B is a block diagram showing a configuration of an operating unit 202 shown in FIG. 2A.

First, referring to FIGS. 2A and 2B, an example of the configuration of the semiconductor integrated circuit device according to the embodiment 1 is described. The semiconductor integrated circuit device according to the embodiment 1 is, for example, a semiconductor integrated circuit device (IC) used in a radio transmitter such as a reader-writer in the UHF band electronic tag (RFID) system, and is formed on one semiconductor chip using a known semiconductor manufacturing technique. The semiconductor integrated circuit device having the radio transmission function consists of, for example, a baseband signal generating unit 201, which generates data for transmission, an operating unit 202, which consists of a multiplier 208, an adder 209, and register 207 to allow control on the modulation depth and the DC bias, a digital/analog converter (DAC) unit 203, which converts a digital signal to an analog signal, a mixer unit 204, which mixes transmission data and a carrier wave, an amplifier unit 205 and the like. Note that, the register 207, the multiplier 208 and the adder 209 in the operation unit 202 are constituted by digital circuits, that is, hardware.

The transmission data generated in the baseband signal generating unit 201 is inputted to the operating unit 202. In the operating unit 202, in order to control the modulation depth and the DC bias, operations are carried out by the multiplier 208 and the adder 209 according to set conditions (operation coefficients) in the register 207, and the result is outputted to the DAC unit 203. In the DAC unit 203, a digital signal of the result of the operation is converted into an analog signal and output to the mixer unit 204. In the mixer unit 204, the transmission data from the DAC unit 203 is mixed with a carrier wave and outputted to the amplifier unit 205. In the amplifier unit 205, the mixed signal is power-amplified and outputted to an antenna 206, and the modulated wave is radio-transmitted from the antenna 206.

The operating unit 202 includes the multiplier 208 for adjusting the modulation depth (amplitude) and the adder 209 for adjusting spectrum power. Further, by adjusting a ratio for addition per one step at the adder 209, power at the rising and the falling can be adjusted, and therefore the spectrum mask at a start and an end of burst data can be adjusted. Note that, by setting a multiplying coefficient for the multiplier 208 and an adding coefficient for the adder 209 in the register 207 in advance, high-integration can be achieved.

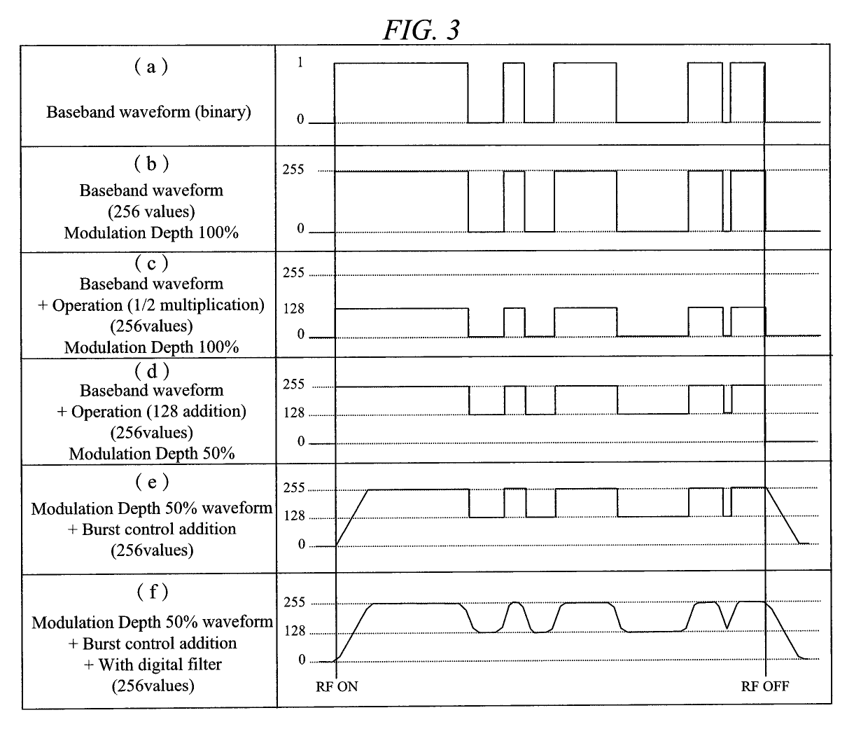

FIG. 3 is a diagram showing examples of a waveform processing in the operating unit 202 in the semiconductor integrated circuit device according to the embodiment 1.

A baseband waveform of (a) is transmission data generated in the baseband signal generating unit 201. The waveform is represented in binary in (a), and a waveform in the case of using 256 values, is shown in a baseband waveform of (b). In this case, the modulation depth is 100%.

By performing a ½ multiplication on the 256-value baseband waveform of (b) with the multiplier 208 in the operating unit 202, a waveform of (c) is obtained. In this case also, the modulation depth is 100%.

By performing a 128 addition on the waveform of (c) by the adder 209 in the operating unit 202, a waveform of (d) is obtained. In this case, the modulation depth is 50%.

By performing a burst control addition on the waveform of (d) with modulation depth of 50% by the adder 209 in the operating unit 202, a waveform of (e) is obtained. In the burst control addition, increment is performed by gradation with time at an RF-ON (rising) and decrement is performed by gradation with time at an RF-OFF (falling).

In the case where a digital filter exists, by making the waveform (e) pass through the digital filter, a waveform of (f) is obtained.

As described above, in the case where only the multiplication is performed on the baseband wave form, the waveform changes in an amplitude direction. As for uniform changes in the amplitude direction, the modulation depth can be adjusted by performing an offset addition (value B in FIG. 1) later. When represented in the spurious, the change causes change in total energy (output power).

In the case where only an addition is performed, the adder causes change in a DC component of the baseband signal. And therefore, the modulation depth, the total energy, and peak power can be changed.

In the case where the adder operates at the rising and the falling, by performing addition (addition of (negative value) at falling) at every one timing in the time axis, the power spectrum of high frequency wave can be decreased and adjustment on the spectrum mask at the rising and the falling becomes possible.

And therefore, by disposing the multiplier and the adder between the baseband signal generating unit and the DAC unit, the ASK modulation depth and the DC bias of the ASK modulated signal can be adjusted easily.

Moreover, since the adder and the multiplier are realized with a digital circuit processing, the processing time can be shorter than the case where they are realized with software.

Furthermore, for a problem of degradation of the spectrum which occurs at the rising and the falling, by realizing the adder and the multiplier with the digital circuit, an external analog circuit is not necessary. And, it takes time to perform an adjustment and testing in the case where an analog circuit is integrated. In this embodiment, since the circuit is realized with a digital circuit, the adjustment is not necessary and the testing time can be shorter.

### Embodiment 2

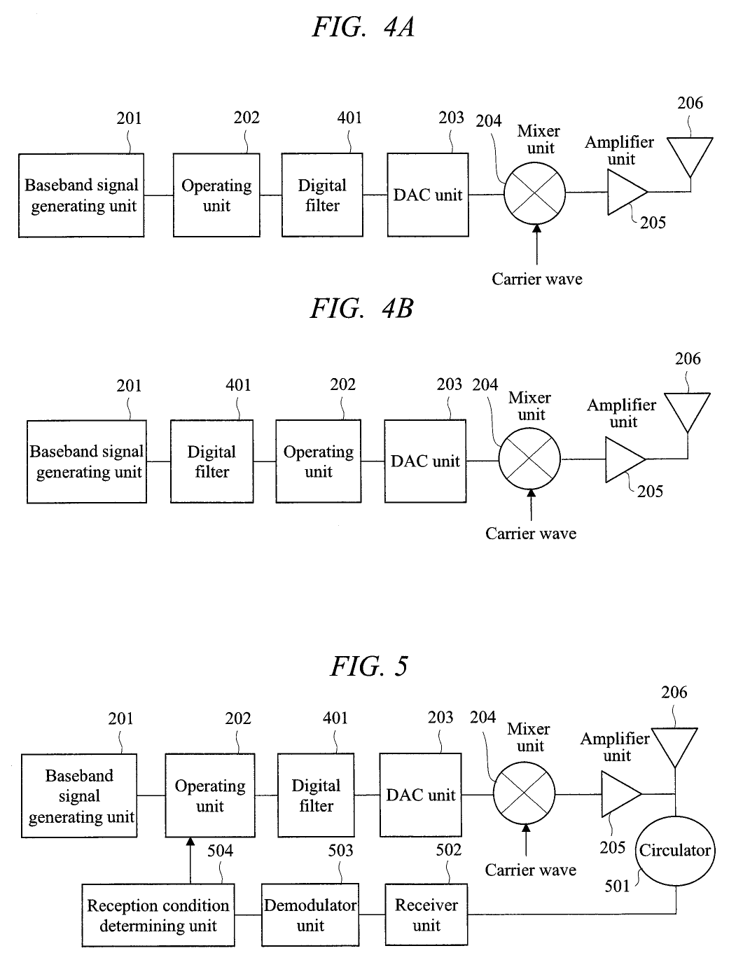

FIGS. 4A and 4B are block diagrams showing configuration of a semiconductor integrated circuit device according to an embodiment 2.

The semiconductor integrated circuit device according to the embodiment 2 is an example in which a digital filter 401 is inserted between the baseband signal generating unit 201 and the DAC unit 203 of the semiconductor integrated circuit device of the embodiment 1.

The operating unit 202 and the digital filter 401 are both logical operations, and therefore either of them can be carried out first. And therefore, the digital filter 401 can be put behind the operating unit 202 as shown in FIG. 4A, or before the operating unit 202.

By adding the digital filter, the waveform at risings and failings is more smoothed.

### Embodiment 3

FIG. 5 is a block diagram showing a configuration of a semiconductor integrated circuit device according to an embodiment 3 of the present invention.

The semiconductor integrated circuit device according to the embodiment 3 is an example in which a circulator 501 which separates a transmission signal and a reception signal, a receiver unit 502 which receives a modulated wave, a demodulating unit 503 which extracts original data from the modulated wave, and a reception condition determining unit 504 which determines a reception condition of addition are added to the semiconductor integrated circuit device (FIG. 4A) of the embodiment 2.

The reception condition determining unit 504 performs the determination on the basis of the original data demodulated by the demodulation unit 503, and the operation coefficients in the register 207 are changed on the basis of a result of the determination.

In a communication system that performs backscatter communication, a transmission condition (the modulation depth, the DC bias, or the like) can be adjusted by determining the reception condition in the reception condition determining unit 504.

And therefore, according to the semiconductor integrated circuit devices of the embodiment 1 to 3, neither an information storage medium nor a high performance operating circuit is necessary. Since a large scale circuit is unnecessary, and high integration and miniaturization can be realized easily.

Moreover, by adjusting the modulation depth and the DC bias in accordance with an establishment condition of the communication, a communication success rate is improved in a communication method in which relatively long communication time is not required, and therefore a performance as a system is improved.

Further, since the adjustments are performed by the operating unit before the DAC unit, fine adjustments can be performed.

Still further, by interlocking the baseband signal generating unit and the operating unit, spectrum spread observed at the rising and the falling can be suppressed, and a time constant circuit which has been realized at the outside is unnecessary.

The present invention can be applied to an integrated circuit for a transmitter of a reader-writer device using a passive type RFID. The present invention can also be applied to an integrated circuit for a transmitter that requires the ASK modulation and needs to be miniaturized.

The reason is that the passive type RFID needs simple communication procedures because of absence of a power source and has short communication time because of a restriction of time for occupying a channel. Further, the reason is that a restriction of the spectrum mask is severe in the communication using RFID of the UHF band, and it is necessary to suppress the spectrum spread by burst communication.

### Embodiment 4

In an embodiment 4, a receiver device as one embodiment of the receiver unit 502 and the demodulator unit 503 shown in FIG. 5 of the embodiment 3 is described.

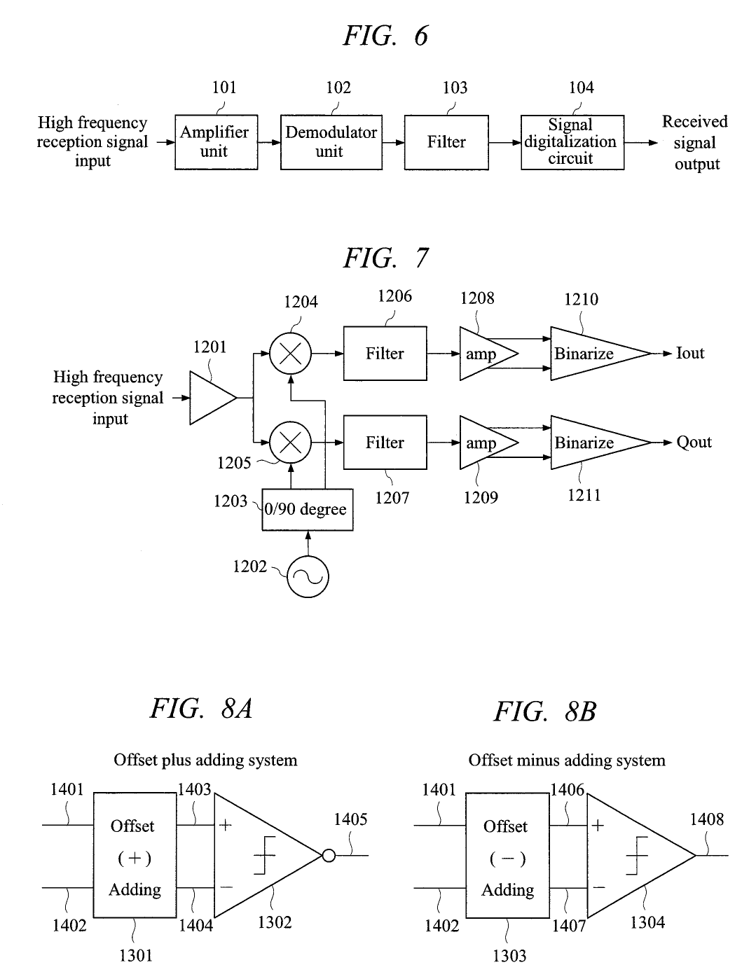

FIG. 6 is a block diagram showing a basic configuration of the receiver device according to the embodiment 4 of the present invention. FIG. 7 is a block diagram showing a specific configuration of the receiver device according to the embodiment 4 of the present invention.

First, referring to FIG. 6, one example of the basic configuration of the receiver device according to the present embodiment is described. The receiver device of the embodiment 4 is used as, for example, a reader-writer device of RFID and composed of a semiconductor integrated circuit (IC) and the like. The receiver device is a receiver device of an ASK signal receiving system and composed of an amplifier unit 101, a demodulator unit 102, a filter 103, a signal digitalization circuit 104 and the like. A high frequency reception signal is inputted to the amplifier 101. An output of the amplifier 101 is inputted to the demodulator 102. An output of the demodulator 102 is inputted to the filter 103. An output of the filter 103 is outputted to the signal digitalization circuit 104, and a reception signal is outputted from the signal digitalization circuit 104.

A specific configuration of the receiver device of FIG. 6 is shown in FIG. 7. The receiver device of FIG. 7 employs a direct conversion method.

As shown in FIG. 7, the receiver device according to the embodiment 4 is composed of an amplifier 1201, an oscillator 1202, a 90 degree phase shift circuit 1203, mixers 1204 and 1205, filters 1206 and 1207, amplifiers 1208 and 1209, binarizing circuits 1210 and 1211 and the like. A high frequency reception signal is inputted to the amplifier 1201. An output of the oscillator 1202 is inputted to the 90 degree phase shift circuit 1203. An output of the amplifier 1201 and an output of the 90-degree phase shift circuit 1203 are inputted to the mixer 1204 and 1205. Outputs of the mixer 1204 and 1205 are inputted to the filters 1206 and 1207. Outputs of the filters 1206 and 1207 are inputted to the binarizing circuits 1210 and 1211. Iout is outputted from the binarizing circuit 1210, and Qout is outputted from the binarizing circuit 1211.

FIGS. 8A and 8B are diagrams showing configurations of the binarizing circuits 1210 and 1211 of FIG. 7 in detail.

Each of the binarizing circuit 1210 and the binarizing circuit 1211 of FIG. 7 includes an offset plus adding system circuit of FIG. 8A and an offset minus adding system circuit of FIG. 8B. The offset plus adding system circuit of FIG. 8A is composed of an offset plus adder 1301, a comparator 1302 and the like. The offset minus adding system circuit of FIG. 8B is composed of an offset minus adder 1303, a comparator 1304 and the like. Input signals 1401 and 1402 to the offset plus adder 1301, input signals 1403 and 1404 to the comparator 1302, input signals 1401 and 1402 to the offset minus adder 1303, and input signals 1406 and 1407 to the comparator 1304 are in relation of differential signals, respectively. Note that, an output signal 1405 of the comparator 1302 and an output signal 1408 of the comparator 1304 are single signals, respectively.

Respective output signals 1401 and 1402 of the amplifier 1208 and the amplifier 1209 are inputted to the offset plus adder 1301 and an offset-plus-adding operation is performed. The results are inputted as the signals 1403 and 1404 to the comparator 1302. A binarized signal 1405 is outputted from the comparator 1302. Further, respective output signals 1401 and 1402 of the amplifier 1208 and the amplifier 1209 are inputted to the offset minus adder 1303 and an offset-minus-adding operation is performed. The results are inputted as the signals 1406 and 1407 to the comparator 1304. A binarized signal 1408 is outputted from the comparator 1304.

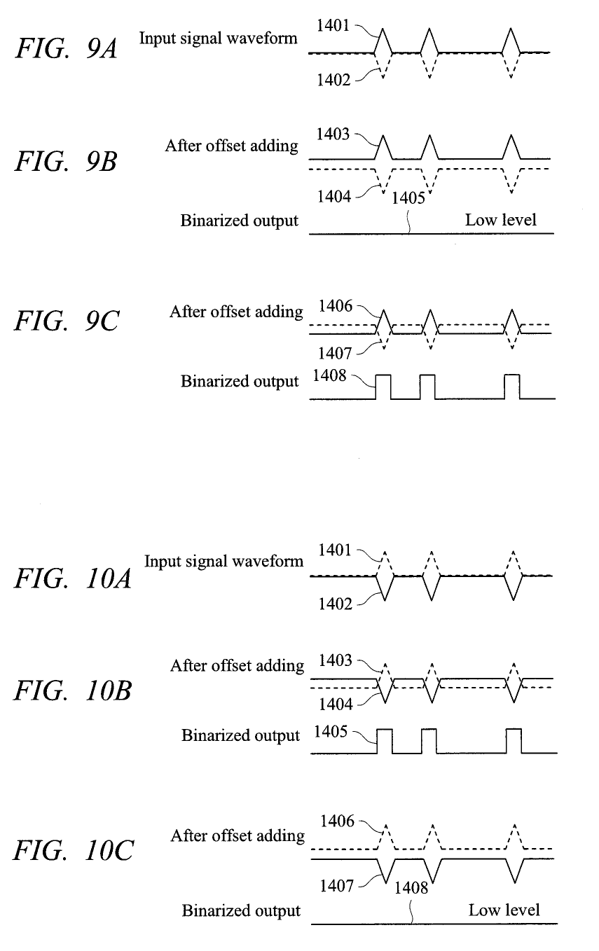

FIGS. 9A, 9B and 9C are diagrams showing waveforms of signals in the case where the inputs of the offset plus adder 1301 and the offset minus adder 1303 are positive signals. FIG. 9A shows input signal waveforms (signal 1401 and 1402) to the offset plus adder 1301 and the offset minus adder 1303. FIG. 9B shows waveforms (signals 1403 and 1404) of signals after an offset-adding operation by the offset plus adder 1301 and the binarized output (signal 1405) of the comparator 1302. FIG. 9C shows waveforms of signals after an offset-adding operation by the offset minus adder 1303 (signals 1406 and 1407) and the binalized output of the comparator 1304 (signal 1408).

As shown in FIGS. 9B and 9C, in the case where inputs are positive signals, the binarized output (signal 1405) by the comparator 1302 is low level, but a pulse appears in the binarized output (signal 1408) by the comparator 1304. And therefore, the first rising edge in the signal 1405 and the signal 1408 is detected, and one of the signal 1405 and the signal 1408 having the first rising edge is selected and fixed to an output signal. In this case, the signal 1408 is selected and the signal is processed thereafter.

FIGS. 10A, 10B and 10C are diagrams showing waveforms of signals in the case where the inputs of the offset-plus adder 1301 and the offset-minus adder 1303 are negative signals. FIG. 10A shows input signal waveforms (signal 1401 and 1402) to the offset-plus adder 1301 and the offset-minus adder 1303. FIG. 10B shows waveforms (signals 1403 and 1404) of signals after an offset-adding operation by the offset plus adder 1301 and the binarized output (signal 1405) of the comparator 1302. FIG. 10C shows waveforms (signals 1406 and 1407) of signals after an offset-added operation by the offset minus adder 1303 and the binarized output (signal 1408) of the comparator 1304.

As shown in FIGS. 10B and 10C, in the case where inputs are negative signals, the binarized output (signal 1408) by the comparator 1304 is low level, but a pulse appears in the binarized output (signal 1405) by the comparator 1302. And therefore, the first rising edge in the signal 1405 and the signal 1408 is detected, and one of the signal 1405 and the signal 1408 having the first rising edge is selected and fixed to an output signal. In this case, the signal 1405 is selected and the signal is processed thereafter.

Note that, in FIGS. 9A to 9C and FIGS. 10A to 10C, a solid line and a broken line are in relation of differential signals. And, in FIG. 9A and FIG. 10A, in portions in which the signal 1401 and the signal 1402 overlap each other are portions of non-modulated signal level.

As described above, comparators 1302 and 1304 respectively corresponding to positive signals and negative signals with respect to the non-modulated signal level of the reception signal are provided, and by detecting one of the comparators 1302 and 1304 which responds from the no-signal state earlier, one of the output signals corresponding to the detected comparator is selected and fixed, and the signal is processed.

By configurations and processing described above, the signal processing can be executed by one circuit without providing a signal processing circuit for each of the positive signal and the negative signal, and a size of the circuit can be reduced. And, selected one of the comparators 1302 and 1304 is released from the selected state on completion of reception of one response, and appropriate one of the comparators 1302 and 1304 is selected newly in the next response. This operation improves the reception characteristic of the reader-writer device.

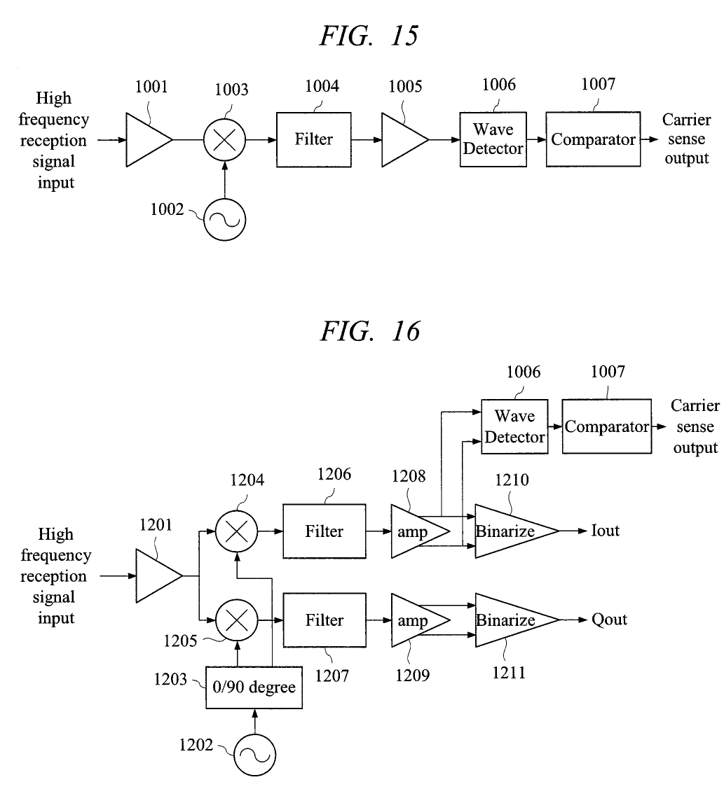

FIG. 15 is a block diagram showing a basic configuration necessary for carrier sense in the present invention.

As shown in FIG. 15, the basic configuration necessary for carrier sense in the present invention consists of an amplifier 1001, an oscillator 1002, a mixer 1003, a filter 1004, an amplifier 1005, a wave detector 1006, a comparator 1007 and the like. A high frequency reception signal is inputted to the amplifier 1001. An output of the oscillator 1002 and an output of the amplifier 1001 are inputted to the mixer 1003. An output of the mixer 1003 is inputted to the filter 1004. An output of the filter 1004 is inputted to the amplifier 1005. An output of the amplifier 1005 is inputted to the wave detector 1006. An output of the wave detector 1006 is inputted to the comparator 1007. A carrier sense is output from the comparator 1007.

Here, it is assumed that an output frequency of the oscillator 1002 is a frequency by which Low-IF lower than or equal to the channel frequency interval can be obtained.

FIG. 16 is a block diagram showing an embodiment of a carrier sense circuit in the present invention.

As shown in FIG. 16, the carrier sense circuit is obtained by adding a wave detector 1006 and a comparator 1007 to the circuit of FIG. 7 in position after the amplifier 1208 of the receiver device.

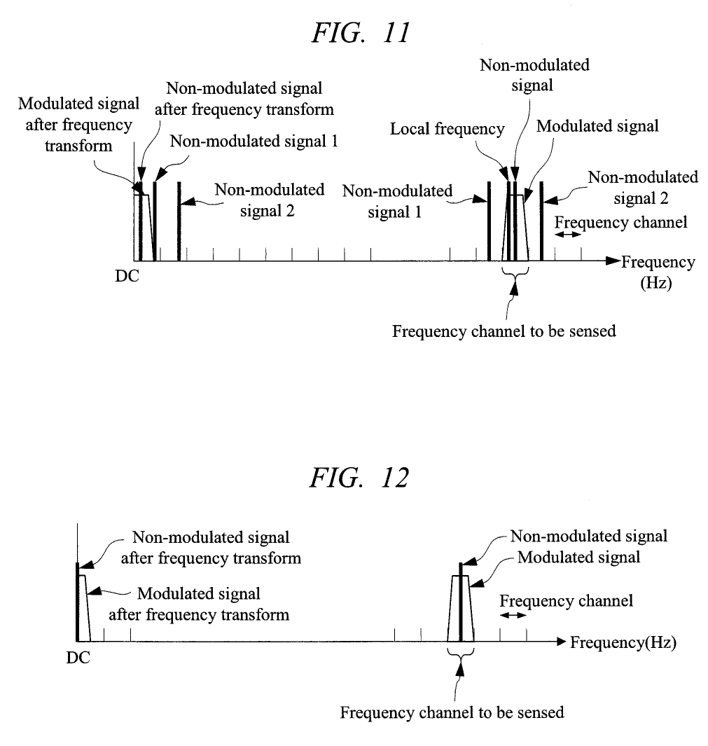

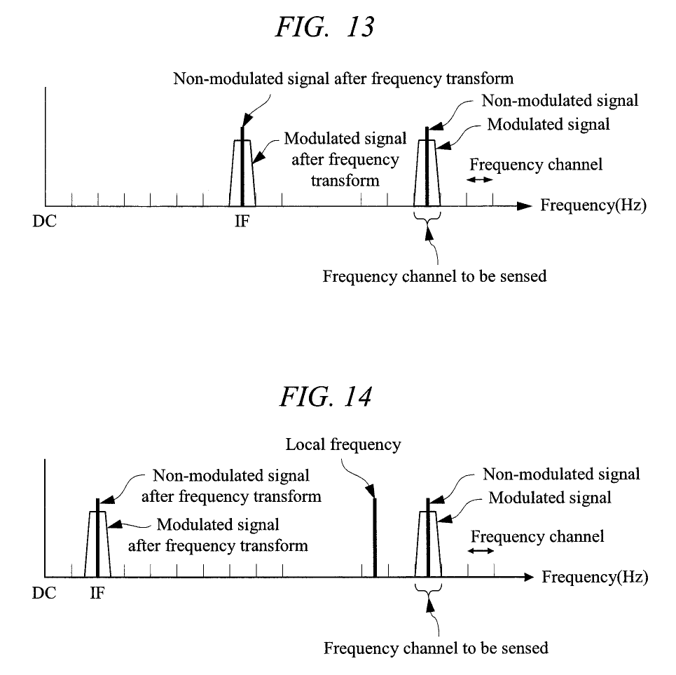

FIG. 11 is an explanation diagram showing process of frequency transform in executing carrier sense in the receiver device according to embodiment 4.

As shown in FIG. 11, if the frequency transform performed in a local frequency lower than the channel frequency, the non-modulated wave is transformed into the IF frequency as well as the modulated wave. Since the IF frequency has a band width which is almost the same as that of the direct conversion, a filter for suppression of undesired signals in the usual signal processing system can be used, and therefore an advantage that an additional filter is not necessary is obtained.

Further, as shown in FIG. 11, unlike the usual Low-IF method, since an image frequency that cannot be separated because of overlapping with another one after the frequency transform does not exits, an advantage that an image rejection technique is not necessary is obtained.

And therefore, in the receiver device according to embodiment 4, “a Low-IF method of an IF frequency lower than or equal to the channel frequency interval” that operates as the direct conversion in the case of receiving a usual response signal and uses an IF frequency lower than or equal to the channel frequency in the case of performing carrier sense is used.

And therefore, since it performs the direct-conversion operation on receiving a usual signal, a mechanism to suppress the image frequency is not necessary. In the case of performing carrier sense, by using an IF frequency lower than or equal to the channel frequency interval, a mechanism to suppress image frequency is not necessary even though in the Low-IF method, and therefore signal processing on modulated wave and non-modulated wave can be executed.

Hereinabove, the present invention achieved by the inventors has been explained specifically based on the embodiments thereof. However, the invention is not restricted to those embodiments. It is obvious that various changes and modifications may be made in a scope of the invention without departing from a gist of the invention.

For example, in the embodiments 1 to 3, the case of the UHF band electronic tag system has been described, but the invention is not limited thereto, and can be applied to transceiver systems of another frequency band.

Further, in the embodiment 4, the receiver device such as a reader-writer device of RFID has been described, but the invention is not limited thereto and can be applied to another receiver device.

The present invention can be applied to an integrated circuit for a transceiver of a reader-writer using a passive type RFID. The present invention is also applicable to an integrated circuit for a transceiver that requires the ASK modulation and needs to be miniaturized.

What is claimed is:

1. A semiconductor integrated circuit device comprising:
a baseband signal generating unit generating data for transmission;
an operating unit performing an operation processing to the data for transmission generated in the baseband signal generating unit;
a digital/analog converting circuit converting a digital signal outputted from the operating unit to an analog signal; and
a mixer unit mixing a signal outputted from the digital/analog converting circuit with a carrier wave,
wherein the operating unit includes a multiplier, an adder, and a register holding operation coefficients for the multiplier and the adder.

2. The semiconductor integrated circuit device according to claim 1,
wherein the operation processing in the operating unit includes an adjustment of a modulation depth and a DC bias to the data for transmission.

3. The semiconductor integrated circuit device according to claim 1,
wherein the operating unit is formed with hardware composed of a digital circuit.

4. The semiconductor integrated circuit device according to claim 1,
wherein the operation processing in the operating unit includes performing increment with time at rising and decrement with time at falling to the data for transmission.

5. The semiconductor integrated circuit device according to claim 1, further comprising:
a receiver unit receiving a modulated wave;
a demodulator unit extracting original data from the modulated wave received at the receiver unit; and
a reception condition determining unit determining a reception condition on the basis of an output of the demodulator unit,
wherein the operation coefficients in the register are changed on the basis of a result of determination by the reception condition determining unit.

6. The semiconductor integrated circuit device according to claim 1,
wherein the semiconductor integrated circuit device is used for a transmitter of a UHF band electronic tag system.

7. A receiver device of a direct conversion method comprising:
a first amplifier inputting a high frequency reception signal;
a demodulator inputting an output of the first amplifier;
a filter inputting an output of the demodulator;
a second amplifier inputting an output of the filter; and
a binarizing circuit inputting an output of the second amplifier,
wherein the binarizing circuit includes an offset-plus adding system circuit and an offset-minus adding system circuit.

8. The receiver device according to claim 7,
wherein the offset-plus adding system circuit includes a first adder executing an offset-plus-adding operation to a differential signal of an output of the second amplifier and a first comparator inputting a differential signal of an output of the first adder, and
wherein the offset-minus adding system circuit includes a second adder executing an offset-minus-adding operation to the differential signal of the output of the second amplifier and a second comparator inputting a differential signal of an output of the second adder.

9. The receiver device according to claim 8,
wherein the second comparator is selected when the output of the second amplifier is a positive signal with respect to a non-modulated signal level, and
wherein the first comparator is selected when the output of the second amplifier is a negative signal with respect to the non-modulated signal level.

10. The receiver device according to claim 8,
wherein one of the first comparator and the second comparator is selected to perform a subsequent signal processing, the one having an output rising first.

11. The receiver device according to claim 8,
wherein the receiver device is used for a reader-writer device for RFID.

12. A receiver device of a direct conversion method comprising:
a first amplifier inputting a high frequency reception signal;
a demodulator inputting an output of the first amplifier;
a filter inputting an output of the demodulator;
a second amplifier inputting an output of the filter;
a wave detecting circuit inputting an output of the second amplifier; and
a comparator circuit inputting an output of the wave detecting circuit,
wherein a Low-IF method with IF frequency lower than or equal to a channel frequency interval is used in performing carrier sense.

13. The receiver device according to claim 12,
wherein the receiver device is used for a reader-writer device for RFID.
